(19) United States
(12) Patent Application Publication
(10) Pub. No.: US 2009/0217793 A1
(43) Pub. Date: Sep. 3, 2009

(54) AUTOMATIC DEFECT DETECTOR AND REJECTER

(75) Inventors: Wayne SPILLNER, Warrenton, VA (US); Jack Pittens, Cambridge (CA); Bradley Woodward, Hamilton (CA); Steven Andrew Park, Burlington (CA)

Correspondence Address: MCGUIREWOODS, LLP, 1750 TYSONS BLVD, SUITE 1800, MCLEAN, VA, 22102, US

(73) Assignee: GreenLine Foods, Inc., Warrenton, VA (US)

(21) Appl. No.: 12/395,055

(22) Filed: Feb. 27, 2009

Related U.S. Application Data
(60) Provisional application No. 61/033,205, filed on Mar. 3, 2008.

(51) Int. Cl. B23D 25/00; B26D 5/38; A23L 1/20

(52) U.S. Cl. 83/289; 83/371; 426/634; 700/160

(57) ABSTRACT

An apparatus, a method and a system for cutting or trimming a portion of an article using a jet stream provided by a nozzle tip. The apparatus includes a drive unit configured to provide a rotational force and a cam assembly connectable to the drive unit and configured to move the nozzle tip to cut the portion of the article. The apparatus includes a conveyor belt that has a void area and a cutting area, and a cam that includes at least one track to drive a frame assembly.

### CROSS REFERENCE TO PRIOR APPLICATIONS

This application claims priority and the benefit thereof under 35 U.S.C. §119(e) from a U.S. Provisional Application No. 61/033,205, filed on Mar. 3, 2008, which is hereby incorporated by reference for all purposes as if fully set forth herein.

### FIELD OF THE INVENTION

The invention generally relates to a system, method, apparatus and computer program for inspecting articles, detecting and identifying defects or flaws, and removing the identified defects from the articles. More particularly, the invention relates a system, method, apparatus and computer program for cutting and/or trimming identified portions from articles using one or more high pressure streams of fluid.

### BACKGROUND OF THE INVENTION

Automatic Defect Removal (ADR) systems are being used in industries such as food processing to automatically detect and identify defects in, for example, frozen food articles, and to automatically remove the identified defective portions from the food articles. FIG. 1 shows an example of an existing ADR system, as described in U.S. Pat. No. 4,520,702 to Davis et al., entitled “INSPECTION AND CUTTING APPARATUS.”

Referring to FIG. 1, the ADR system in U.S. Pat. No. 4,520,702 includes an article inspection and cutting apparatus 10 that is designed for high production processing of elongated articles such as IQF (Individual Quick Frozen) raw potato strips (French Fries). The apparatus 10, which has a framework 20, includes a conveyor 21 (extending from a forward end 23 to a rearward end 24) for moving the articles in line in a large number of transversely spaced lanes past an inspection station 28 and a cutting station 30. Scanning cameras 38, 40, assisted by a lamp bank 34 at the inspection station 28, rapidly scan across the lanes to detect color shade variation in the articles and generate electrical signals characteristic of a defect. A cutting wheel assembly 50, which includes rotating sets of knife wheels, is positioned at the cutting station 30 for selectively projecting two or more knives from the periphery of a wheel to cut sections of the article containing the defect to separate the defective portion from the remainder of the article. In this regard, the traveling knives (i.e., rotating sets of knife wheels) cut the defective portions from the food articles by snapping or breaking the defective portions from the food articles.

Traditionally long slender vegetables such as green beans, wax beans or pea pods are run through a mechanical end snipper that relies on the body diameter and a sharp fixed position blade that slices off the stems and tails. As crop ends are frequently quite irregularly shaped, this end removal or trimming is inherently a non-precise operation that requires a follow-up manual inspection to cull out any product where the snipper missed a stem or damaged a specific “bean body”.

While ADR systems such as the article inspection and cutting apparatus 10 described in U.S. Pat. No. 4,520,702 have proven to be very effective and efficient in identifying and removing defects from frozen food articles, these ADR systems do not perform properly with non-frozen (both field fresh or freshly cooked) food articles, especially vegetables like wax or green beans. Rather than cleanly cutting non-frozen food articles, the moving knife cutters frequently mash or flatten the non-frozen food articles.

### SUMMARY OF THE INVENTION

According to an aspect of the invention, an apparatus is provided for cutting or trimming a portion of an article using a jet stream provided by a nozzle tip. The apparatus comprises: a drive unit configured to provide a rotational force; and a cam assembly connectable to the drive unit and configured to move the nozzle tip to cut the portion of the article. The apparatus may further comprise a conveyor belt comprising a void area and a cutting area. The apparatus may further comprise: a cam comprising a track; and a frame assembly engageable with the track. The cam assembly may be offset and stacked into a six-by-five array. The apparatus may further comprise a pair of the six-by-five array configured for each of two sides of a forty-four lane ADR system. The cam may comprise a second track. The apparatus may further comprise: an inspector configured to detect and determine attributes of the article and generate a control signal based on predetermined criteria, wherein the cam assembly is further configured to move the nozzle tip to cut the portion of the article based on the control signal. The cam assembly may comprise a dual track cam that is configured to move the nozzle tip across a full lane during a 180° rotation. The nozzle tip may be moved to cut the portion of the article in at least one of a substantially 90° angle, a substantially oblique angle, or a substantially variable angle. The nozzle tip may be moved to cut the portion of the article in a French fancy style cut. The nozzle tip may be moved to cut the portion of the article in synchronism with a conveyor belt speed. The nozzle tip may be moved to cut the portion of the article at a speed that is different from a conveyor belt speed. The article may comprise: a green bean; a wax bean; or a pea pod. The drive unit may comprise a speed regulated linear actuator, chain and sprocket with clutch mechanism, or cylinder. The conveyor belt may comprise a stainless steel mesh belt. The apparatus may further comprise a vacuum configured to hold down the article at a force multiple times the weight of the article. The vacuum may comprise a fluid deceleration trough configured to collect the jet stream.

The frame assembly may comprise: a nozzle support member configured to hold the nozzle tip; and a front cam follower support comprising a cam follower configured to engage said track. The apparatus may further comprise a rotator configured to connect the nozzle support member to the front cam follower support. The frame assembly may comprise: a nozzle support member configured to hold the nozzle tip; a front cam follower support comprising a cam follower configured to engage said track; and a rear cam follower support comprising a cam follower configured to engage said track. The frame assembly may further comprise a brace comprising a first end configured to pivotally connect to the front cam follower support and a second end configured to pivotally connect to the nozzle support member. The frame assembly may further comprise: a guide rod having a longitudinal axis, wherein the guide rod guides the front cam follower support or the rear cam follower support in the longitudinal direction, and prevents motion of the front cam follower support or the rear cam follower support in a direction perpendicular to the longitudinal direction. The frame assembly may further comprise: an other guide rod having the longitudinal axis, wherein the other guide rod guides the front cam follower support or the rear cam follower support in the longitudinal direction, and prevents motion of the front cam follower support or the rear cam follower support in a direction perpendicular to the longitudinal direction.

According to another aspect of the invention, a method is provided for cutting or trimming a portion of an article using a jet stream. The method comprises: detecting an article in a field of view; determining attributes of the article; and cutting the portion of the article based on the determined attributes. The method may further comprise: determining location data for the attributes of the article; and generating control data based on predetermined criteria. The method may further comprise: determining if an end of the article is in the field of view; and determining location data for the end. The predetermined criteria may comprise: a length of the article; a width of the article; a color of the article; a brightness of the article; or a lightness of the article. The cutting the portion of the article based on the determined attributes may comprise: trimming one end of the article; and cutting the remaining portion of the article in half. The cutting the portion of the article based on the determined attributes may further comprise driving a dual track cam to move the jet stream from a first position to a second position. The first and second positions may be located over a void area of a conveyor belt. The driving the dual track cam to move the jet stream from the first position to the second position may comprise rotating the dual track cam through substantially 180°.

According to yet another aspect of the invention, a computer readable medium comprising a computer program for cutting or trimming a portion of an article using a jet stream is provided. The medium comprises: an article detecting code section, which when executed, cause detecting an article in a field of view; an attribute determining code section, which when executed, cause determining attributes of the article; and a cutting code section, which when executed, cause cutting the portion of the article based on the determined attributes.

Additional features, advantages, and embodiments of the invention may be set forth or apparent from consideration of the detailed description and drawings. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a known automatic defect removal (ADR) system;

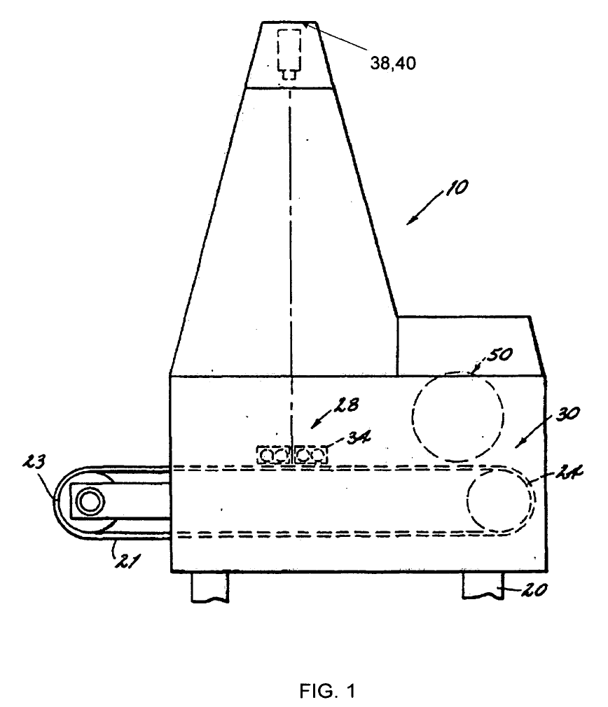

FIG. 2 shows an example of an automatic defect removal (ADR) system 100, according to an embodiment of the invention;

FIG. 3 shows an example of a conveyor belt having three lanes, including a plurality of longitudinal void areas and a plurality of cutting areas;

FIG. 4 shows an example of a nozzle head moving from a first position to a second position, according to the invention, as the nozzle slices across the conveyor belt transporting an article under it;

FIG. 5 shows an example of a nozzle head moving from a first position to a second position in an ADR system having a hold-down conveyor belt system, according to the invention;

FIG. 6 shows an example of a servo cutting head (SCH) assembly, according to a preferred embodiment of the invention;

FIG. 7A shows an example of a nozzle support frame assembly, according to the preferred embodiment of the invention;

FIG. 7B shows a nozzle support frame assembly and cam according to another embodiment of the invention;

FIGS. 8A, 8B, 8C, 8D show various views of an example of a nozzle tip, according to an embodiment of the invention;

FIG. 9 shows an example of a nozzle support frame assembly at four different stages, according to the preferred embodiment of the invention shown in FIG. 7A;

FIGS. 10A, 10B show top and side views, respectively, of an example of a five lane ADR system according to the invention;

FIGS. 11A, 11B, 11C show various views of an example of a forty-four lane ADR system, according to a preferred embodiment of the invention; and

FIG. 12 shows an example of an article trimming process that may be used with an ADR system for cutting and/or trimming articles.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and operating techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention. Moreover, it is noted that like reference numerals represent similar parts throughout the several views of the drawings.

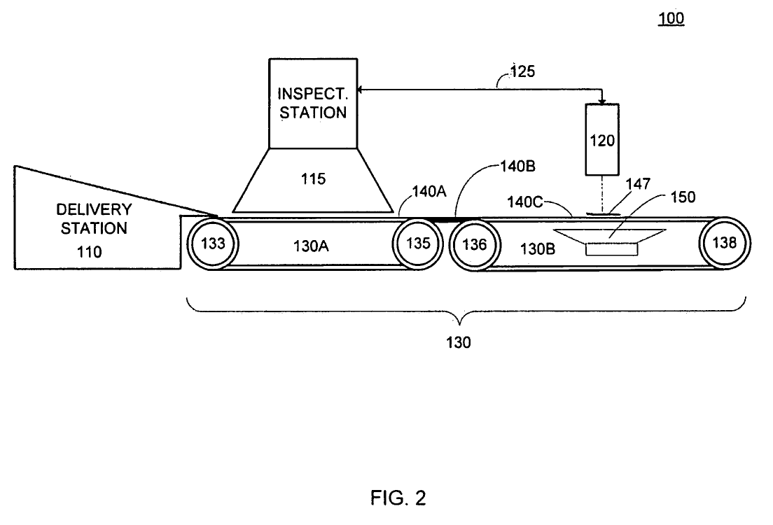

FIG. 2 shows an example of an automatic defect removal system 100, according to an embodiment of the invention. The ADR system 100 is includes a delivery station (or article deliverer) 110, an inspection station (or inspector) 115, a cutting station (or cutter) 120 and a conveyor system (or conveyor) 130. The delivery station 110 may be configured to receive articles (such as, for example, but not limited to, green beans, wax beans, pea pods, raw (unfrozen or frozen) potato strips, carrots, or the like), cull out certain of the received articles according to a predetermined criteria (such as, for example, a shape or curvature of the article, one or more dimensions of the article, a size of the article, a weight of the article, or the like) and properly position or align the remaining articles (e.g., in single-file into one or more proper lane(s)) for inspection in the inspection station 115. The delivery station 110 may include, for example, without limitation, a slotted Iso-flow® shaker made by Key Technology, Inc. (not shown), a conventional grading table for manual inspection (not shown), or any other known culling device or method that may be capable of culling out the received articles according to the predetermined criteria and positioning or aligning the remaining articles 147 for proper inspection in the inspection station 115 and subsequent cutting/trimming in the cutting station 120.

The inspection station 115 may be configured to inspect the articles 147 for defects, such as, for example, but not limited to, blemishes, shade variation defects, color variation defects, shape variation defects, size variation defects, textural defects, internal defects, or the like. The inspection station 115 may include, for example, an electro-optical inspection system, such as, e.g., the vision system described in U.S. Pat. No. 4,520,702, which uses red, green, infrared, or even ultraviolet light spectrum ranges to detect and identify defects in received articles.

The inspection station 115 may provide digital control signals to the cutting station 120 via a communication link 125. The communication link 125 may include an electrical medium (such as, e.g., electrical wire, or the like), an optical medium (such as, e.g., an optical fiber, or the like), or a wireless medium, or any combination thereof. The digital control signals may include, e.g., timing signals, position signals, conveyor belt speed information, servo speed control signals (including acceleration/deceleration data), and the like, without limitation, specifying the timing and spatial requirements for cutting and/or trimming articles. After inspection at the inspection station 115, the inspected articles may be moved along the conveyor system 130 to the cutting station 120.

The inspection station 115 may include a computer (not shown) capable of determining the ideal place(s) to cut and/or trim a specific analyzed article, thereby optimizing its final appearance while maximizing the throughput yield (considering, e.g., length, quantity and quality as parameters). The computer (not shown) may include any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, or the like. Alternatively, the computer (not shown) may be provided in a location other than the inspection station 115.

The conveyor system 130 may include, for example, conveyor subsystems 130A and 130B. The conveyor subsystem 130A may include a conveyor belt 140A made of a material (such as, for example, translucent polyurethane, or the like) that facilitates detection and identification of defects in the articles that are carried on the surface of the conveyor belt 140A by the inspection station 115. The conveyor subsystem 130A includes a drive mechanism (not shown) (such as, e.g., an electric motor, combustion engine, or the like) for driving the conveyor belt 140A to move the articles thereon through the inspection station 115 to the cutting station 120. The drive mechanism (not shown) may be synchronized with the visions system (not shown) in the inspection station 115, the cutting station 120 and the conveyor subsystem 130B to provide accurate detection, identification and removal or trimming of portions of the articles that are carried on the surface of the conveyor belt 140A. The conveyor belt 140A may be supported by a plurality of pulleys 133, 135.

After the articles are inspected at the inspection station 115, the articles may be carried by the conveyor belt 140A to the conveyor subsystem 130B, across a bridge section 140B (such as, e.g., a multi-lane plate, or the like). The conveyor subsystem 130B may include a conveyor belt 140C made of a material such as, for example, but not limited to stainless steel, polyurethane, titanium, carbon fiber, and/or any other hard material that is resistant to corrosion and wear due to, e.g., a high-pressure fluid (or gas) jet stream, with (or without) abrasive additives. Further, the conveyor belt 140C may include a mesh-like pattern, grate-like pattern, or the like, having openings to allow fluids (such as, e.g., water) and gases (such as, e.g., air) to pass through the conveyor belt 140C. Furthermore, the conveyor belt 140C may include a longitudinal void (or open) area on both sides of each of one or more lanes. The conveyor subsystem 130B may include a vacuum station 150 configured to provide negative pressure (such as, e.g., three times the apparent weight or mass of the article being cut—preferably four times, but less than seven times to avoid crushing or smashing the article) to firmly hold down the articles carried on top of the conveyor belt 140C while they are cut/trimmed at the cutting station 120.

The vacuum station 150 may be configured to suction any mist that may be generated by the cutting station 120, thereby minimizing any effect of the mist on, for example, the vision system in the inspection station 115. However, alternative methods may equally be used such as, for example, implementing a positive air fan, or the like, to force the mist away from, e.g., the inspection station 115. The vacuum station 150 may include a fluid deceleration tank (not shown) to capture all of the jet streams in the cutting station 120. The primary discharge of all of the jet streams may be directed into a common (or an interconnected network of a plurality of) deceleration collection trough(s) that safely collect and sewer the waste water or use it for other tasks like local green belt irrigation or de-soiling-washing the incoming articles (such as, e.g., crops) fresh from, e.g., the field. The collection trough(s) may be filled with a fluid (such as, e.g., water, or the like) designed to collect the fluid jet streams. Further, a secondary trough (or network of troughs) may be included to collect the fluid from the collection trough(s) and, e.g., sewer the collected fluid.

The conveyor subsystem 130B includes a drive mechanism (not shown) (such as, e.g., an electric motor, combustion engine, or the like, and one or more sprockets, or the like) for driving the conveyor belt 140C to move the articles thereon through the cutting station 120. The drive mechanism (not shown) may be synchronized with the visual system in the inspection station 115, the cutting station 120 and the conveyor subsystem 130A to provide accurate removal of the defective portions of the articles carried on the surface of the conveyor belt 140C. Furthermore, the same drive mechanism may drive both conveyor subsystems 130A, 130B. The conveyor belt 140C may be supported by a plurality of pulleys 136, 138.

The conveyor system 130 may include n number of lanes (or channels) for independently carrying, inspecting and cutting n articles in parallel, where n is a positive integer greater than, or equal to 1. According to embodiments of the invention, the ADR system 100 may have, for example, 1, 2, 3, 4, 5, . . . , 44, or more lanes. In this regard, the conveyor belts 140A, 140C may each include a single belt carrying n lanes of articles or n belts, with each of the n belts carrying a single article.

Further, the conveyor system 130 may include, for example, an additional belt (not shown) on each side of a particular lane, thereby forming a trough in each of the n lanes to precisely guide the articles on the n cutting areas of the conveyor belt 140C. These belts may move in a speed matched mode with the primary conveying belt 140C in the lower part of the trough to substantially eliminate relative motion between the walls and base of the moving trough, which may damage the article carried therein. The additional belts may terminate just before the cutting station 120, where they are replaced by voids in the conveyor belt 140C, after the bridge 140B (which may include, e.g., a low friction transition dial plate) that allow for unobstructed passage of fluid jet streams in the cutlery zone (or cutting area).

The ADR system 100 may further include a spray bar (not shown) and brush (not shown) on the underside of the conveyor belt 140C to keep the conveyor belt 140C clean in the cutter area (or zone), so the fluid jet streams can easily pass through it. This intermittently or continuous flow of discharged fluid may be collected by a trough system and sewered or allowed to be collected in a floor sump system.

According to a preferred embodiment of the invention, a single conveyor system (not shown) may be used instead of the conveyor subsystems 130A, 130B. In this alternative embodiment, the conveyor system (not shown) may include the conveyor belt 140C to carry articles from the delivery station 110, past the inspection station 115, to the cutting station 120. In this regard, the inspection station 115 may be configured to inspect, detect and identify defects in articles carried on the conveyor belt 140C. Urethane belts (not shown) may be provided that rise and lower, forming moving speed synchronized side guides for the conveyor belt 140C troughs (not shown) that transport the individually aligned articles to be interrogated by the inspection station 115. The side guides drop as the articles pass through the inspection station 115. The side guides then drop flat with the conveyor belt 140C and stop where they get replaced by voids in the conveyor belt 140C where the fluid jet streams are positioned in their no-cut positions. This preferred option eliminates the transfer point across the bridge 140B (such as, e.g., a dead plate), allowing more precise control and awareness of where each lane's article cuts are to be made. This embodiment will deliver even better “pack out” yield.

The computer (not shown) that may be located in the inspection station 115 may be provided with a computer readable medium containing a computer program with instructions that, when executed on the computer, cause the visual inspection system (not shown) in the inspection station 115 to detect attributes of an article in a field of view (FOV) of the visual inspection system (such as, e.g., color, lightness, darkness, texture, internal characteristics, length, width, thickness, or the like, and variations of color, lightness, darkness, texture, internal characteristics, length, width, thickness, or the like, across the body of the article). The computer program contains further instructions, which when executed on the computer cause a location data to be determined and stored for the detected attributes of the article in the FOV, as well as to nozzle head control data to be generated based on predetermined criteria, including, for example, but not limited to an article type (such as, e.g., green bean, wax bean, pea pod, carrot, pepper, banana, or the like), a length (such as, e.g., about 3.3 inches to about 6.5 inches for green beans or wax beans), a width, a thickness, a color, a lightness/darkness, a texture, whether to cut one or both ends of the article, and the like, or gradations of length, width, thickness, color, lightness/darkness, texture, and the like. The predetermined criteria may be coded into the computer program, or provided as inputs (or entries) through an input/output interface (not shown).

The computer program may also contain instructions to send the generated control data to the cutting station 120 to cut and/or trim the analyzed article according to the predetermined criteria. Thus, for example, the inspection station 115 can determine green bean flaws or blemishes and generate control signals to cut and/or trim out the specified flaws or blemishes. Further the cutting station 120 may cut, for example, only the stem end of a green bean, or cut the green bean in half, or the like—a tail end without other near-by determined damage or defects may be left alone. Thus, modifying the inspection defect or cutting criteria for the computer program can optimize the location and number of cuts required for a particular article, thereby resulting in improved “pack out” product yield.

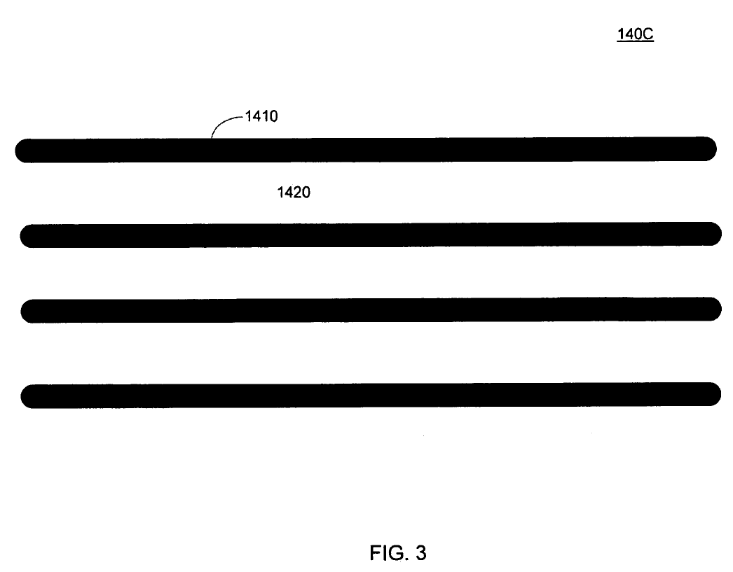

FIG. 3 shows an example of a conveyor belt 140C having three lanes (i.e., n=3), including a plurality of longitudinal void areas 1410 and a plurality of cutting areas 1420, according to an aspect of the invention.

The cutting station 120 includes n nozzle heads 210 for cutting articles carried in each of the n lanes based on the digital control signals received from the inspection station 115 over the communication link 125. Each of the n nozzle heads is controlled to slice through a portion of, or an entire article in a corresponding lane.

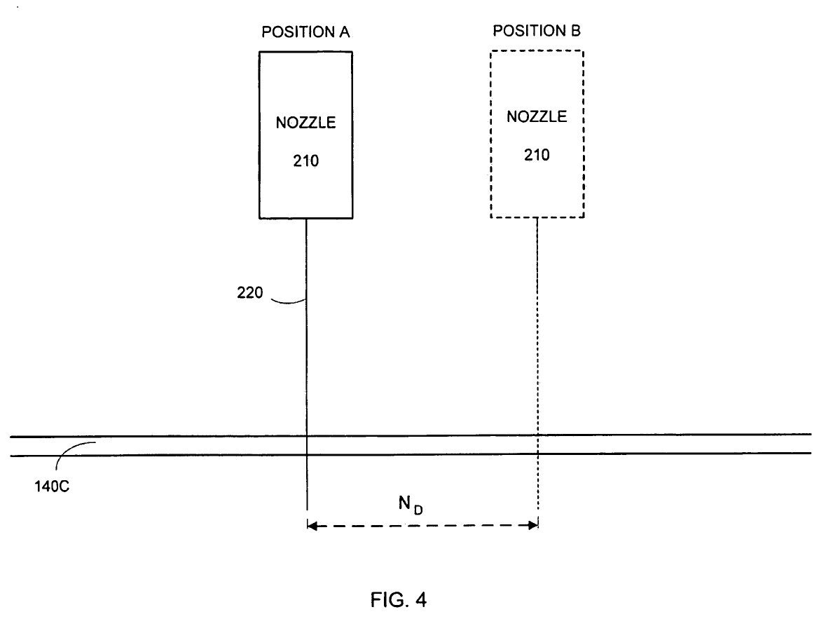

FIG. 4 shows an example of a nozzle head 210 moving from a position A to a position B across a length N_{D}, where N_{D} is set according to type of article. For example, for long slender green vegetables like green beans, wax beans, pea pods, and the like, N_{D} may be set in the range of, for example, about 1 to 3 inches, and preferably 1.5 inches or less to maximize “pack out crop yield.” The nozzle head 210 may eject a high-pressure jet stream 220 to trim and/or cut an article located atop the conveyor belt 140C. The nozzle head 210 may be configured to provide a straight cut that is synchronized with the speed of the conveyor belt 140C below it when the slicing action across the conveyor belt lanes occurs.

For example, the nozzle head 210 may eject a jet stream 220 at a pressure of about 25,000 psi to 45,000 psi using, e.g., a jewel orifice in the nozzle tip. A jet stream 220 in the range between 25,000 psi and 45,000 psi can develop a stream velocity approaching mach 3 upon discharge to atmosphere out of the jewel orifice. The jet stream 220 may include, for example, a high-pressure stream of fresh conditioned/purified water passed through a nozzle with a jewel orifice tip sized between 3 and 8 mils in diameter to cleanly slice through the body, stalk or stem of the article, thereby delivering the appearance of the product being cut with a very sharp surgical scalpel or knife blade. A visual system (not shown) provided in the inspection station 115 (shown in FIG. 2) may establish where the jet stream 220 is to cut and/or trim in order to deliver optimized yield and quality pieces meeting pre-established length range criteria, so that a production line can further process and package the cut/trimmed articles for shipment to the end user or distributor. For green beans, wax beans, pea pods, and the like, the cut length range may be set to a length in the range of, for example, between about 3.3 inches to about 6.5 inches. Nubbins or short pieces with a pre-determined short “cut length” (such as, e.g., 2.6 inches, or less) may be removed using, for example, a down-stream rotary cup pocket size grader (not shown), or size sorter/shaker (not shown), or the like, provided down-stream of the conveyor belt 140C.

It is noted that in the preferred embodiment of the invention, the forward motion of the jet stream 220 for an article moving at a speed in a range of about 75 fpm and about 160 fpm may be between 0.75 inch and 1.5 inch, depending a response time, acceleration rate and/or inductance of, for example, a servo motor (not shown) used to drive the nozzle head 210.

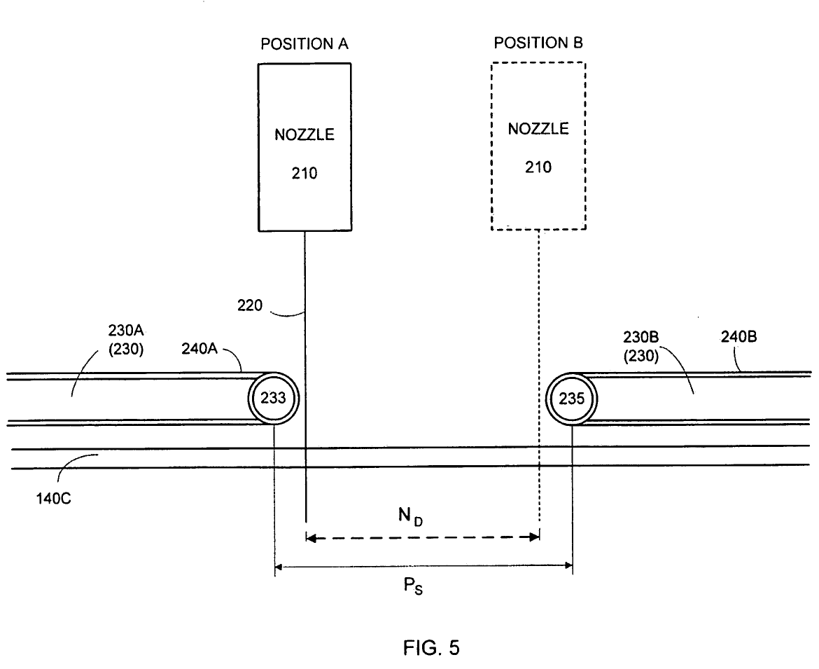

FIG. 5 shows an example of a nozzle head 210 moving from the position A to the position B across the length N_{D} in an ADR system 100 that includes a hold-down conveyor belt system 230 instead of (or in addition to) the preferred vacuum station 150 shown in FIG. 2 to provide negative pressure to the articles on the conveyor belt 140C. The hold-down conveyor belt system 230 may include hold-down conveyor belt subsystems 230A, 230B, each of which may include a conveyor belt 240A, 240B, respectively, and a plurality of pulleys 233, 235. The conveyor belts 240A, 240B, may be made from the same material as the conveyor belts 140A or 140C. The pulleys 233, 235 may be spaced at a distance P_{S}, which may be in the range of, for example, about 1 17/32 inches to 2 17/32 inches, and preferably 2 1/32 inches for long slender green vegetables like green beans, wax beans, pea pods, or the like. Further, the length N_{D} may be in the range of, for example, about 1 to 2 inches, and preferably 1.5 inches for long slender green vegetables like green beans, wax beans, pea pods, or the like.

The hold-down conveyor belt system 230 is configured to provide a hold down force on each end of the article being cut, allowing both sides of an internal blemish as well as both ends of the article to be trimmed as necessary and triggered by the inspection station 115. This hold down force must at least increase the apparent weight of the article being cut by 3 times—preferably 4 times but less than 7 times (to avoid crushing or smashing of the article), so that the article won't be displaced when contact with the cutting jet stream 220 is first encountered (jerk).

The ADR system 100 may be configured to process articles at a rate that is preferably in the range of, e.g., approximately 115 feet-per-minute (fpm) to approximately 230 fpm. That is, the conveyor belts 140A, 140C may be moved at a speed in the range of, e.g., about 115 fpm (23 in/s) to about 230 fpm (46 in/s). It is noted, however, that other processing rates may be equally used.

According to an embodiment of the invention, the nozzle head 210 may include a stationary pivoting head properly positioned for each trimmer lane that may be air cylinder, cam or electric linear actuator operated for the motion to cut through the long slender articles moving immediately under it when the vision system triggers a cut cycle. This side to side cutting motion could even be triggered by a clutch actuated chain and sprocket drive driven from the main conveyor belt drive shaft. Accordingly, an angular cut (such as, e.g., a “French fancy style” cut) of, e.g., between ½ inch to 1 inch long can be achieved, depending on the production line speed of the conveyor belt 140C.

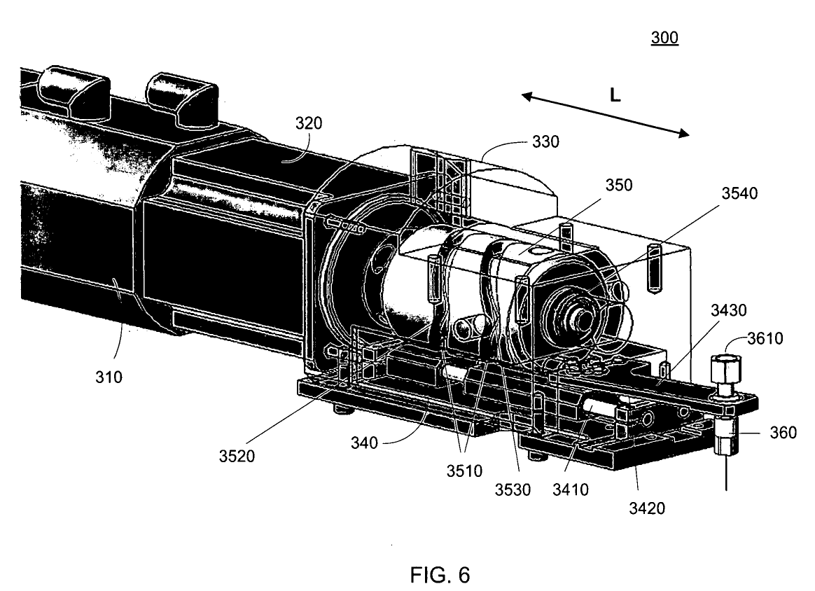

FIG. 6 shows an example of a servo cutting head (SCH) assembly 300, according to the preferred embodiment of the invention. The SCH assembly 300 includes a drive-unit body 310, a gear assembly body 320, a cam assembly body 330, a nozzle support frame assembly 340, a cam 350, and a nozzle tip 360 that has an opening 3610 for receiving a liquid (or gas) under high pressure. The drive-unit body 310 may include a drive unit (not shown), such as, e.g., an electric servo motor, or the like, which may be coupled to a gear assembly (not shown) enclosed in the gear assembly body 320. The gear assembly (not shown) may be coupled to the dual-barrel cam 350 through a drive shaft (not shown) to convey a rotational force to the cam 350 from the drive unit (not shown) around a longitudinal axis L, while allowing the cam 350 to move back and forth along the longitudinal axis L. A lubricant (such as, e.g., the PhyMet™ food grade product, MPF-0696 that is both an H-1 and H-2 lubricant, or the like, without limitation, which contains corrosion inhibitors, antioxidants and wear/friction reducing additives) may be used on all moving parts to reduce friction, prevent wear of components, reduce heat build-up, and reduce power consumption.

According to an alternative embodiment, the drive-unit body 310 may include a line shaft (not shown) or chain drive (not shown) to use one motor with an electric clutch to turn one or more cams 350, instead of a dedicated servo motor to a single cam 350.

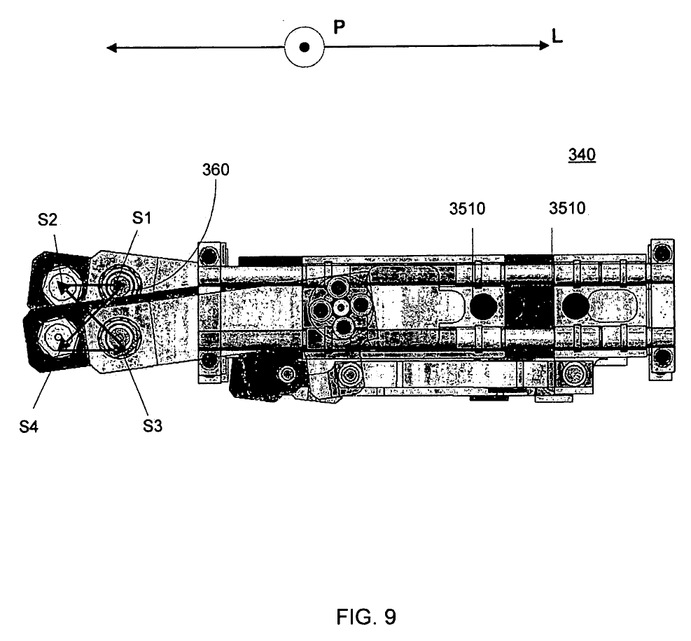

The cam assembly 330, which includes the cam 350, may include a plurality of cam followers (such as, e.g., cam pins, or the like) 3510 mated to a pair of tracks (barrels or channels) 3520, 3530. The cam followers 3510 may include rotating followers, such as, e.g., those made by McGill™ or Torrington™. The cam followers 3510 are guided and forced by the tracks 3520, 3530 in the cam 350 to move back and forth on a pair of guide rods 3410, 3420 along the longitudinal axis L. The cam 350 may be configured to provide, for example, two servo cycles during a single 360° rotation of the cam 350. In this regard, the first servo cycle may result in a jet stream (from the nozzle tip 360) sweeping across the article path in a particular lane from a first no-cut position (such as, e.g., over a void area in the conveyor belt) on one side of the cutting area of the conveyor belt to another no-cut position on the opposite side of the cutting area (another void area in the conveyor belt). The second servo cycle may result in the jet stream sweeping back in synchronous speed with the article from the second no-cut position to the first no-cut position. An example of the servo mechanism motion from two relatively consecutive cycles of the cam 350 is shown below in FIG. 9.

The servo cutting head assembly 300 may also include a precision shaft encoder or resolver to allow the cam operated servo mechanisms to maintain their forward motion speed-matching or velocity-synchronization with the lower speed conveyor belt 140C transporting the single file (lane), aligned articles under each of the cutting nozzle tips 360.

It is noted that more than two tracks (barrels or channels) may be provided in the cam 350. It is also noted that different milled track configurations may be provided on the cam 350 to deliver different nozzle tip position cutting patterns.

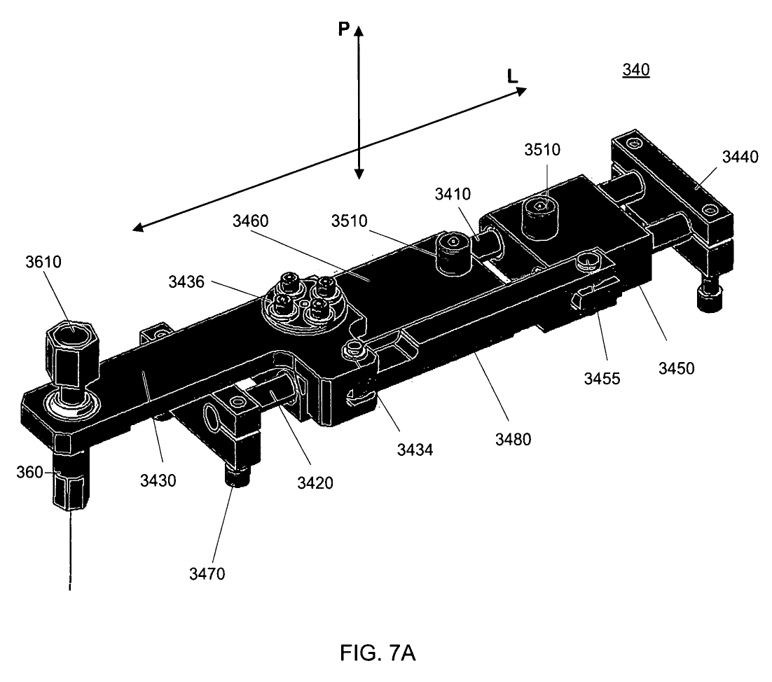

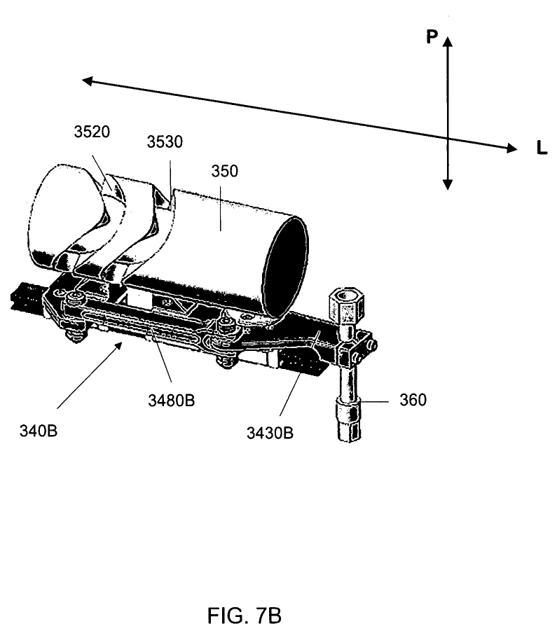

An example of the nozzle support frame assembly 340 is shown in greater detail in FIG. 7A. The nozzle support frame assembly 340 may include a pair of guide rods 3410, 3420, and a nozzle support member 3430 to which the nozzle tip 360 may be affixed. The operation of the nozzle support frame assembly 340 is controlled by cycling the servo motor driven cam causing the two cam followers 3510 to move relative to each other.

It is further noted that the nozzle tip 360 may include, for example, a 3-mil to 8-mil jewel orifice, or the like, in its tip (not shown). The liquid that that is supplied to the opening 3610 of the nozzle tip 360 may include, for example, water that is provided at a pressure in the range of, for example, about 25,000 psi to 45,000 psi, which may cause a mach 3 jet stream to be developed by the nozzle tip 360. The water to be supplied to the nozzle tip 360 may be filtered and/or conditioned to remove, e.g., colloids, contaminants, impurities, minerals or other particulate matter, as well as bacteria, viruses, or the like, before being provided to, e.g., a high pressure pump (not shown). The water may also be treated to provide an optimum pH level, such as e.g., between about 4 pH and 10 pH.

FIG. 7A shows the nozzle support frame assembly 340 in greater detail, according to the embodiment of the invention.

Referring to FIG. 7A, in addition to the guide rods 3410, 3420, and nozzle support member 3430, the nozzle support frame assembly 340 also includes a rear bracket 3440, a rear cam follower support 3450, a front cam follower support 3460, and a front bracket 3470. The cam follower support 3460 may include rotating followers, such as, e.g., those made by McGill™ or Torrington™. The guide rods 3410, 3420 are affixed to the rear bracket 3440 at one end and to the front bracket 3470 at the other end. The rear cam follower support 3450 and front cam follower support 3460 are supported and guided by the guide rods 3410, 3420, which are stationary, as the rear cam follower support 3450 and front cam follower support 3460 slide back and forth along the longitudinal axis L. The rear cam follower support 3450 and front cam follower support 3460 are configured to move based on longitudinal forces (along the longitudinal axis L) conveyed from the tracks 3520, 3530, to the rotating cam followers 3510. The linear guide rods 3410, 3420 provide linear shafting for higher stiffness, longer life, lower weight, lower initial costs and lower refurbishment costs.

As seen in FIG. 7A, the rear cam follower support 3450 is pivotally coupled to one end of a brace 3480 by means of a pin 3455. The other end of the brace 3480 is pivotally coupled to the nozzle tip support member 3430 by means of another pin 3434. The nozzle tip support member 3430 is rotatably coupled to the front cam follower support 3460 by means of, for example, a polymer filled stainless steel bearing assembly (rotator) 3436 that is rotatable about the main pivot axis P to allow high stiffness and long life.

FIG. 7B shows the nozzle support frame assembly 340B and dual-barrel cam 350 according to another embodiment of the invention. As seen in FIG. 7B, the brace 3480B is located on the opposite side with respect to the brace 3480 shown in FIG. 7A. Further, the nozzle tip support member 3430B may be configured as a mirror of the nozzle tip support member 3430 in FIG. 7A. The dual cam tracks 3520, 3530, controlling the cam followers 3510 may be cut such that the relative motion between the cam followers 3510 allows the nozzle tip 360 to move forward with a speed matched velocity to the conveyor belt below as the nozzle tip 360 crosses the belt, cutting the article on it and, and then rapidly retracts within the void area to the side of the belt transporting the article streams.

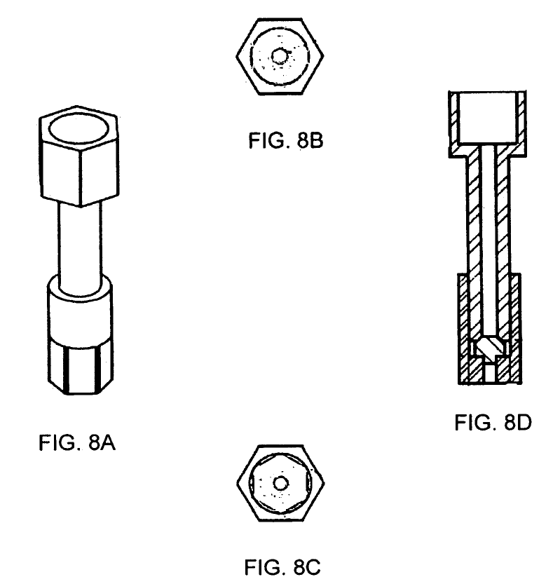

FIGS. 8A, 8B, 8C, 8D, show various views of an example of a nozzle tip that may be used for the nozzle tip 360. In particular, FIG. 8A shows a top-down view of the nozzle tip; FIG. 8B shows a bottom-up view of the nozzle tip; FIG. 8C shows a side view of the nozzle tip; and FIG. 8D shows an internal view of the nozzle tip. The preferred nozzle tip orifice diameter to develop the required fluid cutting streams is between about 3 mil to 8 mil, using, e.g., a diamond jewel for maximum life expectancy. A diamond jewel can be easily replaced, and it is recommended that the jewel be exchanged & cleaned in, e.g., an ultrasonic bath every 3 to 5 months to maintain optimal performance. Using, for example, a sapphire or ruby jewel will work, but it is likely to wear out faster and it may be necessary to exchange the jewel every 3 to 5 months for superior effectiveness.

FIG. 9 shows an example of the nozzle support frame assembly 340 of FIG. 7A at four different stages of, e.g., the two cycle operation of the cam 350 during a single 360° rotation of the cam 350. As seen, the nozzle support member 3430, including the nozzle tip 360, is moved (e.g., during a single cycle) from position S1 to position S4 (S1→S4), from position S4 to position S3 (S4→S3), where it rests (i.e., at position S3). Then, the nozzle support member, including the nozzle tip 360 is moved (e.g., during a second cycle) from position S3 to position S2 (S3→S2), and, from position S2 back to position S1 (S2→S1), where it rests. That is, the nozzle support frame assembly 340 may be configured so that the nozzle tip support member 3430 moves the nozzle tip 360 through the four different positions S1, S2, S3, S4 during the two cycle operation (with each cycle corresponding to a single cut across the cutting area of a particular lane). The first cycle may include, e.g., the following sequence of movements: S1→S4→S3. The second cycle may include, e.g., the following sequence of movements: S3→S2→S1. The durations of the first and second cycles may be substantially the same, or different. The duration for each cycle may be synchronized to the speed of the conveyor belt 140C which carries the articles. For a cycle time of, e.g., 100 ms, the cam 350 must spin at an average speed of 5 hz (300 rpm).

The nozzle tip support member 3430 is moved due to forces exerted by the cam tracks (barrels or channels) 3520, 3530 (shown, e.g., in FIG. 7A) on the cam followers 3510 on the rear cam follower support 3450 and front cam follower support 3460, respectively. The nozzle support frame assembly 340 may be configured to move, e.g., about 1 inch to 1.3 inches along the longitudinal axis L.

Referring to FIGS. 3, 4 and 9, according to an aspect of the invention, the nozzle head 210 (FIG. 4) may be positioned so that the jet stream 220 is aligned over the void area 1410 (FIG. 3) in the conveyor belt 140C. For example, the nozzle tip may be located in the positions S1 or S3 (shown in FIG. 9). Accordingly, a continuous jet stream 220 may be provided by the nozzle head 210. The jet steam 220 may be moved along the trajectory S1→S4→S3 or S3→S2→S1 for a single servo cycle (such as, e.g., a 180° rotation of the cam 350 shown in FIGS. 6 and 7B). For a perpendicular cut (i.e., a 90° cut with regard to the longitudinal direction of the cutting area 1420, shown in FIG. 3), movement of the nozzle head 210 may be synchronized with the speed of the conveyor belt 140C, so that the jet stream 220 will move across the cutting area 1420, perpendicular to the direction of travel of the conveyor belt 140C. For an oblique angle cut (i.e., other than a 90° cut), the nozzle head 210 may be controllably operated at a faster or slower rate than the speed of the conveyor belt 140C (such as, e.g., rotating the cam 350 at a higher or lower rate than required to synchronize the rotation of the cam 350 to obtain a perpendicular cut). Furthermore, for a varying angle cut, the nozzle head 210 may be moved at varying speed (i.e., acceleration or deceleration) with regard to the speed of the conveyor belt 140C (such as, e.g., accelerating or decelerating the rotation of the cam 350 with regard to the speed of the conveyor belt 140C).

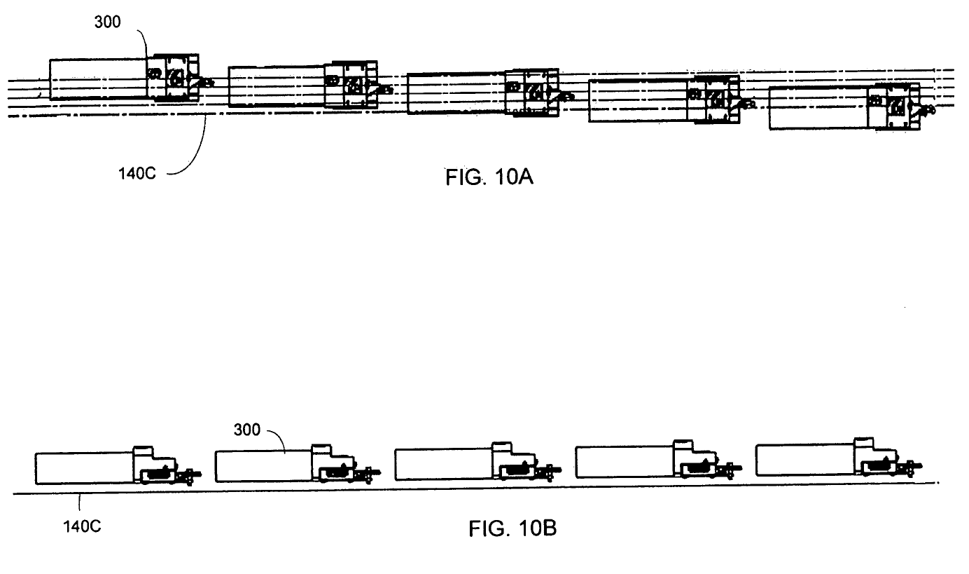

FIGS. 10A, 10B show an example of a five lane (n=5) ADR system, according to the invention. In particular, FIG. 10A shows a top-down view of the ADR system and FIG. 10B shows a side-view of the ADR system. As seen in FIG. 10A, the ADR system includes an array of five nozzle heads 300 and a five lane conveyor belt 140C.

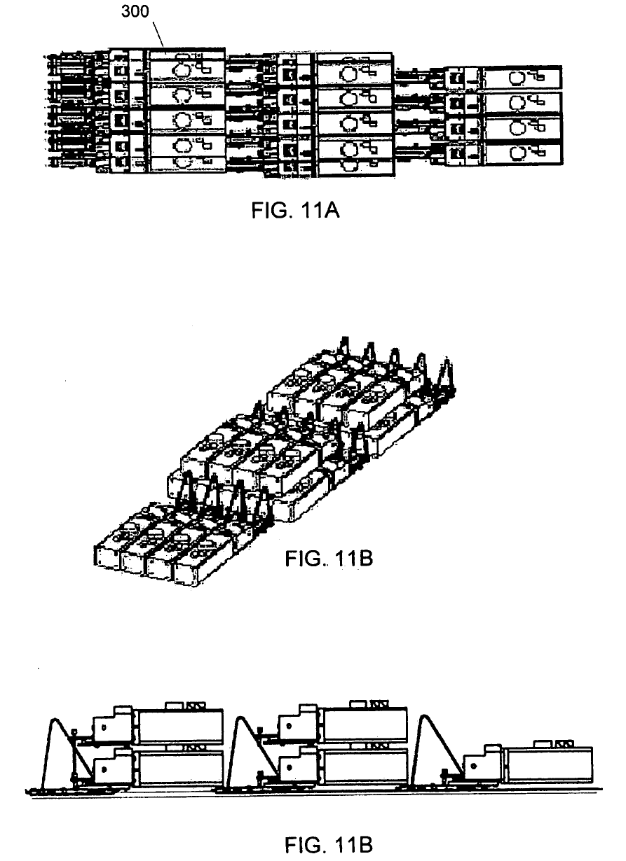

FIGS. 11A, 11B, 11C show an example of a forty-four lane (n=44) ADR system, according to the invention. In particular, FIG. 11A shows a top-down view of the 44-lane ADR system; FIG. 11B shows a perspective view of the 44-lane ADR system; and FIG. 11C shows a side view of the 44-lane ADR system. As seen in FIG. 11A, 11B, 11C, the ADR system includes two triple-arrays of twenty-two (22) nozzle heads 300 positioned above a forty-four lane conveyor belt 140C. The conveyor belt 140C may include two independent sides of twenty-two lanes each. Further, two dual-arrays of heads 300 may be offset and stacked one on top of the other, including six below and five above, for each of the two sides of the ADR system making the mechanics slightly simpler.

Alternatively, the ADR system may include two stacked arrays of heads 300, including six heads 300 in a lower row and five heads 300 in a top row. One of the arrays may be positioned forward and the other array may be positioned rearward, with each of two sides having its own independent twenty-two lanes of conveyor belt 140C under each of these two arrays.

In FIGS. 10A, 10B, or FIGS. 11A, 11B, 11C, each nozzle head 300 may be independently controlled to cut/trim articles provided on the conveyor belt 140C in an associated lane by moving from a void area on one side of a particular lane in the conveyor belt 140C to a void area on the other side of the lane in the conveyor belt 140C. The nozzle head 300 is configured to provide a continuous high pressure jet stream, which crosses across the conveyor belt 140C cutting area when making a computer directed cut or trim through the article at a determined location and time. Accordingly all forty-four nozzle heads 300 (or five nozzle heads in FIGS. 10A, 10B) may be ejecting high pressure fluid continually at approximately mach 3. However, because of a small orifice size in the nozzle heads 300, the total fluid consumption will only be between, e.g., about 2.8 gpm and 4.4 gpm for all forty-four nozzle heads. The force/intensity of the ejected jet streams will slice through article bodies and stems, resulting in ideal clean, complete cuts.

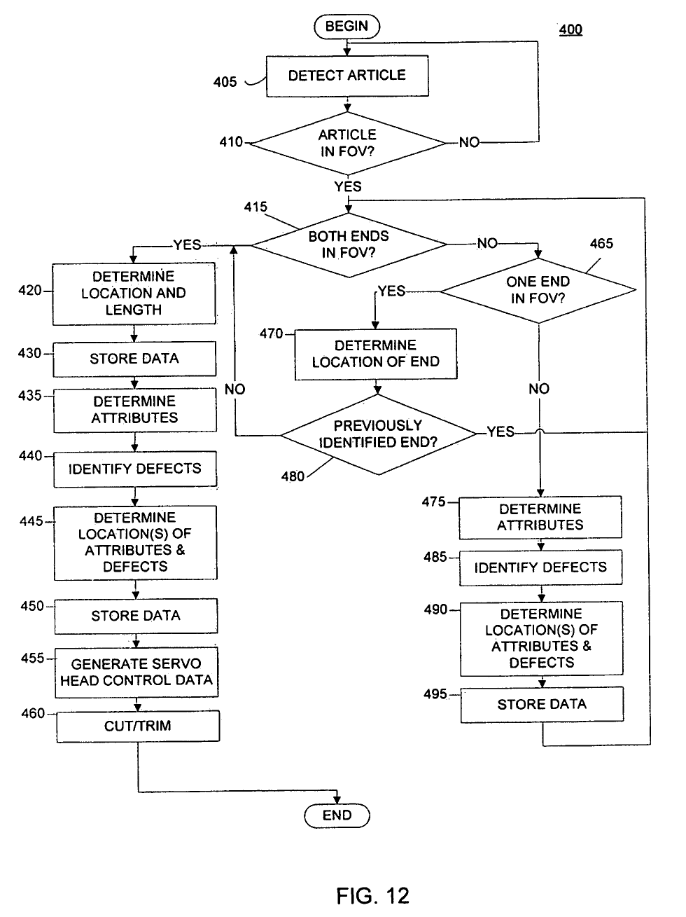

FIG. 12 shows an example of an article cutting/trimming process 400 that may be used to drive a single nozzle head in an ADR system to trim and/or cut articles to, e.g., maximize product quality and product yield. The article cutting/trimming process 400 is described below for a single lane, with illustrative (but not limiting) references to FIGS. 2, 3, 4, 9 and 12.

Initially, a nozzle head 210 (shown in FIG. 4) may be located in position S1 or S3 (shown in FIG. 9), so that the jet stream 220 is aligned with the void area 1410 (shown in FIG. 3) in the conveyor belt 140C. The inspection station 115 monitors the surface of the conveyor belt 140A (or 140C in the alternative embodiment) to detect an article located on the surface (Step 405). If the inspection station 115 detects an article within a field of view (FOV) (YES, Step 410), then it proceeds to determine whether both ends of the article are in the field of view (Step 415), otherwise it continues to monitor for an article (NO, Step 410).

If both ends of the article are determined to be in the field of view (YES, Step 415), then the length of the article and the locations of its ends are determined (Step 420), otherwise a determination is made whether one end of the article is in the field of view (Step 465). The location data for each end and the length of the article is stored in a memory (not shown) (Step 430). Then, attributes of the article (such as, e.g., color, lightness, darkness, texture, or the like, and variations of color, lightness, darkness, texture, or the like, across,the body of the article) are analyzed and determined (Step 435). Based on the analysis (Step 435), defects in the article are determined and identified (Step 440). Location data is determined for each of the attributes and defects on the article (Step 445). The location data is stored in the memory (not shown) (Step 450).

On the basis of the attribute data, defect data and the location data, as well as the speed of the conveyor belt 140C, control data is generated to drive the jet stream 220 to cut and/or trim the article according to predetermined criteria (such as, e.g., optimal length, color, lightness, darkness, texture, aesthetic style (e.g., “French fancy style”), or the like, or variations thereof across the body of the article) (Step 455). The control data is then sent to the nozzle head 210 to drive the nozzle head 210 to move the jet stream 220 such that the article is cut and/or trimmed according to the received control data (Step 460).

For example, when an article is determined to have a length above a predetermined threshold length (such as, e.g., 8 inches for green beans) and one end is determined not to meet predetermined criteria (such as, e.g., an end of a green bean is a light green color, or the end contains a defect or blemish), the control data may include an instruction to trim the lighter (or defective) end of the article and cut the remaining portion into predetermined lengths (such as, e.g., 2.5 inch to 5 inch lengths for green beans). Alternatively, if no surface defect is detected, then the lighter-colored end of the article may be trimmed and the remaining portion cut in half when one end is determined to be a desired color (such as, e.g., very dark green for green beans); or, both ends may be trimmed and the remaining portion of the article cut in half when no end is determined to be the desired color. Further, if the article is determined to have a length less than the predetermined threshold length, then control data may include an instruction to trim only the lighter (or defective) end of the article and cut the remaining portion into predetermined lengths (such as, e.g., 2.5 inch to 7.5 inch lengths for green beans). The control data may also include an instruction to trim both ends of the article.

If, however, it is determined that both ends of the article are not in the field of view (NO, Step 415), then a determination is made whether one end of the article is in the field of view (Step 465). If it is determined that one end of the article is in the field of view (YES, Step 465), then a location is determined for that end of the article (Step 470), otherwise attributes of the article (such as, e.g., color, lightness, darkness, texture, or the like, and variations of color, lightness, darkness, texture, or the like, across the body of the article) are analyzed and determined for the article (Step 475) (NO, Step 465). After the location has been determined for the end of the article (Step 470), then a determination is made whether that end of the article was previously identified by, for example, comparing the location of that end of the article to a previously stored location of an end of an article (Step 480). If it is determined that the end was previously identified (YES, Step 480), then the process returns to detect when the other end of the article is in the field of view (Step 415). However, if it is determined that the end of the article was not previously identified (NO, Step 480), then the process proceeds to determine the location of the newly determined end and length of the article (Step 420).

After it is determined that one end of the article is in the field of view (YES, Step 465), and the attributes of the article have been determined (Step 475), then defects in the article may be determined and identified based on the attributes (Step 485). Location data is determined for each of the determined attributes and defects on the article (Step 490). The location data for each of the attributes and defects, together with the attribute data and defect data, is stored in the memory (not shown) (Step 495). Then, the process returns to detect whether both ends are in the field of view (Step 415).

According to a further aspect of the invention, a computer program embodied in a computer readable medium is provided, which when executed on a computer (such as, e.g., the computer provided in the inspection station 115) causes each of the Steps 405 to 495 to be carried out. In particular, the computer program contains a plurality of instructions (such as, e.g., code sections or code segments), including an instruction for each of the Step 405 through 495. The logic minimizes the number of cuts while maximizing the yield sent on for further processing.

While the invention has been described with a fluid jet cutter, a laser cutter or a high pressure gas cutter may equally be used, without departing from the scope or spirit of the invention.

It is noted that unless expressly indicated otherwise, each element, component or system of components may be made from a metal (such as, e.g., aluminum, stainless steel, iron, brass, copper, nickel, or the like, without limitation), a synthetic or semisynthetic organic solid material (such as, e.g., plastics), a fully synthetic material, or any combination thereof suitable for the manufacture of industrial products.

According to an aspect of the present invention, food articles, such as, e.g., long slender vegetables, including green beans, wax beans or pea pods may be cut and/or trimmed to, for example, to slice off stems and/or tails, cut/trim out defects, cut/trim the vegetables into predetermined lengths/widths, trim the vegetables with aesthetic-type cuts (such as, e.g., wavy-length-wise cuts, or the like). As crop ends are frequently quite irregularly shaped, the invention provides for automated, precise identification and removal of stems, damaged portions of a “bean body,” or the like.

Although the preferred utility of the invention is for cutting and/or trimming food articles, such as, e.g., green bean, wax bean, pea pod, carrot, pepper, banana, or the like, without limitation, the invention may be used to cut/trim other types of articles, such as, e.g., paper products, wood products, plastic products, or the like, without limitation.

The invention reduces damage caused by current snipper end trimming methods. Thus, integrating the invention into a production line will increase productivity by eliminating or reducing the need for manual inspectors to ensure that the stem removal operation was accomplished properly while improving “pack out” yield, since the trimming is more closely controlled and tails don't need to be cut off. Surface defects may be sliced out rather than discarding the entire article with a detected flaw that is currently accomplished in, for example, field harvested bean inspection equipment. Acceptable length articles may be delivered down the line for further processing and final packaging.

The novel dual cycle twin barrel cam servo-mechanism delivers a simple to control, preferred system and method for integrating a fluid jet cutter to trim articles such as, e.g., fresh vegetables due to its repeatable, predictable, faster and more consistent system response time.

The preferred dual servo cycle per revolution of the two track barrel cam with a vacuum hold-down mechanism to maintain control of the individual articles as they are cut provides an easy way to effectively hold down articles while regulating mist associated with operation of the jet streams.

According to a further aspect of the invention the invention, by adjusting the nozzle tip orifice size and the associated water pressure, the ADR system can slice through articles such as, e.g., frozen vegetables (including frozen potato strips), extruded “candy or baked loaded pastry” bars and similar food items where this trimming and flaw detection would be valuable. Green beans clearly need the improved stem removal and gentler handling provided by this invention as other slicing methods risk product damage, incomplete cutting of the individual product bodies or cross contamination from a “dirty cutting surface”. All these issues are eliminated by the present invention.

The up and down stream equipment to, e.g., handle articles, cull out immature articles, nubbins, align the articles into single files (or lanes), and the like, can be done by various material handling systems and machinery already developed for these functions. The slotted vibratory alignment Iso-flow™ shaker developed by Key does an excellent job in presenting aligned, laned single file streams of product to the inspection station. The inspection station may be controlled according to predetermined discrimination criteria to optimize the location and number of cuts to deliver maximum quality and yield to the down stream further processing and packaging equipment.

While the invention has been described in terms of exemplary embodiments, those skilled in the art will recognize that the invention can be practiced with modifications in the spirit and scope of the appended claims. These examples are merely illustrative and are not meant to be an exhaustive list of all possible designs, embodiments, applications or modifications of the invention.

What is claimed:

1. An apparatus for cutting or trimming a portion of an article to a predetermined size, including trimming at least one end of the article or removing a defect from the article using a jet stream provided by a nozzle tip to optimize packed out yield, the apparatus comprising:
a drive unit configured to provide a rotational force; and
a cam assembly connectable to the drive unit and configured to move the nozzle tip to cut the portion of the article according to predetermined criteria,
wherein the article.

2. The apparatus according to claim 1, further comprising:
a conveyor belt comprising a void area and a cutting area.

3. The apparatus according to claim 1, further comprising:
a cam comprising a track; and
a frame assembly engageable with the track.

4. The apparatus according to claim 1, wherein the cam assembly is offset and stacked into a six-by-five array.

5. The apparatus according to claim 4, further comprising:
a pair of the six-by-five array configured for each of two sides of a forty-four lane ADR system.

6. The apparatus according to claim 3, wherein the cam comprises a second track.

7. The apparatus according to claim 3, wherein the frame assembly comprises:
a nozzle support member configured to hold the nozzle tip; and
a front cam follower support comprising a cam follower configured to engage said track.

8. The apparatus according to claim 7, further comprising:
a rotator configured to connect the nozzle support member to the front cam follower support.

9. The apparatus according to claim 6, wherein the frame assembly comprises:
a nozzle support member-configured to hold the nozzle tip;
a front cam follower support comprising a cam follower configured to engage said track; and
a rear cam follower support comprising a cam follower configured to engage said track.

10. The apparatus according to claim 9, wherein the frame assembly further comprises:
a brace comprising a first end configured to pivotally connect to the front cam follower support and a second end configured to pivotally connect to the nozzle support member.

11. The apparatus according to claim 10, wherein the frame assembly further comprises:
a guide rod having a longitudinal axis, wherein
the guide rod guides the front cam follower support or the rear cam follower support in the longitudinal direction, and
prevents motion of the front cam follower support or the rear cam follower support in a direction perpendicular to the longitudinal direction.

12. The apparatus according to claim 11, wherein the frame assembly further comprises:
an other guide rod having the longitudinal axis, wherein
the other guide rod guides the front cam follower support or the rear cam follower support in the longitudinal direction, and
prevents motion of the front cam follower support or the rear cam follower support in a direction perpendicular to the longitudinal direction.

13. The apparatus according to claim 1, further comprising:
an inspector configured to detect and determine attributes of the article and generate a control signal based on predetermined criteria,
wherein the cam assembly is further configured to move the nozzle tip to cut the portion of the article based on the control signal.

14. The apparatus according to claim 13, wherein the cam assembly comprises a dual track cam that is configured to move the nozzle tip across a full lane during a 180° rotation.

15. The apparatus according to claim 1, wherein the nozzle tip is moved to cut the portion of the article in at least one of a substantially 90° angle, a substantially oblique angle, or a substantially variable angle.

16. The apparatus according to claim 1, wherein the nozzle tip is moved to cut the portion of the article in a French fancy style cut.

17. The apparatus according to claim 1, wherein the nozzle tip is moved to cut the portion of the article in synchronism with a conveyor belt speed.

18. The apparatus according to claim 1, wherein the nozzle tip is moved to cut the portion of the article at a speed that is different from a conveyor belt speed.

19. The apparatus according to claim 1, wherein the article comprises:
a green bean;
a wax bean; or
a pea pod.

20. The apparatus according to claim 1, wherein the drive unit comprises a speed regulated linear actuator, chain and sprocket with clutch mechanism, or cylinder.

21. The apparatus according to claim 2, wherein the conveyor belt comprises a stainless steel mesh belt.

22. The apparatus according to claim 1, further comprising:
a vacuum configured to hold down the article at a force multiple times the weight of the article.

23. The apparatus according to claim 22, wherein the vacuum comprises:
a fluid deceleration trough configured to collect the jet stream.

24. A method for cutting or trimming a portion of an article using a jet stream, the method comprising:
detecting an article in a field of view;
determining attributes of the article; and
cutting the portion of the article based on the determined attributes.

25. The method according to claim 24, further comprising:
determining location data for the attributes of the article; and
generating control data based on predetermined criteria.

26. The method according to claim 24, further comprising:
determining if an end of the article is in the field of view; and
determining location data for the end.

27. The method according to claim 25, wherein the predetermined criteria comprise:
a length of the article;
a width of the article;
a color of the article;
a brightness of the article; or
a lightness of the article.

28. The method according to claim 27, wherein the cutting the portion of the article based on the determined attributes comprises:
trimming one end of the article; and
cutting the remaining portion of the article in half.

29. The method according to claim 28, wherein the cutting the portion of the article based on the determined attributes further comprises:
driving a dual track cam to move the jet stream from a first position to a second position.

30. The method according to claim 29, wherein the first and second positions are located over a void area of a conveyor belt.

31. The method according to claim 29, wherein driving the dual track cam to move the jet stream from the first position to the second position comprises rotating the dual track cam through substantially 180°.

32. A computer readable medium comprising a computer program for cutting or trimming a portion of an article using a jet stream, the medium comprising:
an article detecting code section, which when executed, cause detecting an article in a field of view;
an attribute determining code section, which when executed, cause determining attributes of the article; and
a cutting code section, which when executed, cause cutting the portion of the article based on the determined attributes.

33. An article processed by the apparatus according to claim 1.

34. An article processed by the method according to claim 24.
